(19) United States
(12) Patent Application Publication
(10) Pub. No.: US 2024/0343948 A1
(43) Pub. Date: Oct. 17, 2024

(54) PRESSURE-SENSITIVE ADHESIVE TAPE INCLUDING SULFUR AND RELATED PROCESSES

(71) Applicant: 3M INNOVATIVE PROPERTIES COMPANY, St. Paul, MN (US)

(72) Inventors: Jian Li, London (CA); Prince P. Antony, London (CA)

(21) Appl. No.: 18/694,926

(22) PCT Filed: Sep. 27, 2022
(86) PCT No.: PCT/IB2022/059197

§ 371 Date: Mar. 22, 2024

Related U.S. Application Data
(60) Provisional application No. 63/248,589, filed on Sep. 27, 2021.

(51) Int. Cl. C09J 7/38; C09J 5/06

(52) U.S. Cl. CPC C09J 7/383; C09J 5/06; C09J 2301/302; C09J 2301/408; C09J 2301/50; C09J 2400/283

(57) ABSTRACT

The tape includes a backing and a pressure-sensitive adhesive applied from an aqueous dispersion on the backing. The pressure-sensitive adhesive includes an at least partially crosslinked elastomer, a tackifying resin, and sulfur. A process for making the tape includes applying an aqueous dispersion of an elastomer, the tackifying resin, and the sulfur to the backing and drying the aqueous dispersion to provide the pressure-sensitive adhesive on the backing. A process of using the tape includes applying the tape to a surface and exposing the surface to a temperature of at least 150° C.

### CROSS-REFERENCE TO RELATED APPLICATION

This application claims priority to U.S. Provisional Application No. 63/248,589, filed Sep. 27, 2021, the disclosure of which is incorporated by reference in its entirety herein.

### BACKGROUND

In some tape applications, it is beneficial to be able to use the tape at relatively high temperatures. For example, in the painting of automobile bodies, a high drying/curing temperature between several painting steps can decrease the drying/curing time. Tapes that are based on rubbers can degrade at high temperatures. Heat-reactive crosslinkers have been used to counteract such degradation. Masking tapes that include rubbers and heat-reactive crosslinkers are typically made by solvent-coating a pressure-sensitive adhesive composition. Hot-melt adhesive formulations are limited in that commonly used heat-reactive crosslinkers cannot be added to the mixer. Crosslinking of the rubber composition in the mixer during hot melt processing can cause gel specks in the composition and fluctuations in viscosity. The consequences may be streaks and substantial fluctuations in the weight of composition applied to a tape and the reduction of the crosslinking potential during application. Moreover, if a hot melt line is halted, the rubber composition including crosslinkers may crosslink completely in the regions of elevated temperatures, greatly jeopardizing the ability to start up the line again without cleaning.

Some pressure-sensitive adhesives that include a phenolic crosslinker made by various hot melt processes are disclosed in U.S. Pat. No. 6,822,029 (Burmeister et al.) and U.S. Pat. No. 8,680,178 (Meier et al.) and European Patent Application Publication 0668335, published Feb. 17, 1994. Water based pressure-sensitive adhesives including a variety of curing agents are described in U.S. Pat. No. 5,728,759 (Pike).

### SUMMARY

The present disclosure provides a rubber-based tape useful, for example, for higher temperature applications.

In one aspect, the present disclosure provides a tape that includes a backing and a pressure-sensitive adhesive applied from an aqueous dispersion on the backing. The pressure-sensitive adhesive includes an at least partially crosslinked elastomer, a tackifying resin, and sulfur.

In another aspect, the present disclosure provides a process of making the tape described above. The process includes applying an aqueous dispersion of an elastomer, the tackifying resin, and the sulfur to the backing and drying the aqueous dispersion to provide the pressure-sensitive adhesive on the backing.

In another aspect, the present disclosure provides an aqueous dispersion of an elastomer, a tackifying resin, and sulfur.

In another aspect, the present disclosure provides a process for using the tape described above. The process includes applying the tape to a surface and exposing the surface to a temperature of at least 150° C. In other words, the present disclosure provides the use of the tape at a temperature of at least 150° C.

In this application:

Terms such as “a”, “an” and “the” are not intended to refer to only a singular entity but include the general class of which a specific example may be used for illustration. The terms “a”, “an”, and “the” are used interchangeably with the term “at least one”.

The phrase “comprises at least one of” followed by a list refers to comprising any one of the items in the list and any combination of two or more items in the list. The phrase “at least one of” followed by a list refers to any one of the items in the list or any combination of two or more items in the list.

The term “hydrocarbon elastomer” refers to elastomers that have only carbon and hydrogen atoms. Hydrocarbon elastomers exclude acrylic, urethane, and silicone elastomers and acrylonitrile butadiene rubber.

The terms “crosslinked” and “crosslinking” refers to joining polymer chains together by covalent chemical bonds to form a network polymer. A crosslinked polymer is generally characterized by insolubility but may be swellable in the presence of an appropriate solvent. The term “crosslinked elastomer” includes partially crosslinked elastomers.

The term “elastomer” refers to a molecule having a structure which essentially includes the multiple repetition of units derived, actually or conceptually, from molecules of low relative molecular mass. As used herein, the term “elastomer” is synonymous with “rubber”.

Room temperature refers to a temperature range of 20° C. to 25° C.

All numerical ranges are inclusive of their endpoints and nonintegral values between the endpoints unless otherwise stated (e.g., 1 to 5 includes 1, 1.5, 2, 2.75, 3, 3.80, 4, 5, etc.).

### DETAILED DESCRIPTION

Rubber-based tapes (e.g., natural rubber-based tapes) are often not useful above 300° F. (149° C.) due to degradation of the rubber adhesive at these temperatures. The present disclosure provides a tape including a pressure-sensitive adhesive (PSA) that includes sulfur. While this disclosure is not intended to be bound by theory, the sulfur is believed to induce at least partial crosslinking of the elastomer in the PSA. The pressure-sensitive adhesive is applied to the tape backing from an aqueous dispersion. It is possible, although not required, to crosslink the elastomer by passing the tape through an oven at a temperature useful for drying the aqueous dispersion (e.g., in a range from 160° F. (71° C.) to 250° F. (121° C.), or higher). It is also possible, although not required, to crosslink the elastomer by exposure to radiation. Furthermore, during use at 200° F. (93° C.) or higher or 300° F. (149° C.) or higher, the sulfur can continue to crosslink the elastomer, thereby counteracting any degradation of the elastomer at such temperatures.

The tape of the present disclosure includes a backing. The backing can be any suitable polymeric film material, paper, or a polymer-cloth laminate. Polymeric materials suitable for the backing include polyesters; polyolefins (e.g., polyethylene, propylene); ethyl cellulose film; cellulose esters (e.g., cellulose acetate, cellulose acetate butyrate, and cellulose propionate); polyvinylidene chloride-vinyl chloride and/or acrylonitrile polymers such as saran; vinyl chloride polymers (e.g., poly(vinyl chloride) and copolymers of vinyl chloride and vinyl acetate); polyfluoroethylenes (e.g., polytetrafluoroethylene and polytrifluorochloroethylene); polyvinyl alcohol; polyamides such as nylon; polystyrenes such as the copolymers of styrene and isobutylene; regenerated cellulose; benzyl cellulose; cellulose nitrate; gelatin; glycol cellulose; flexible acrylate and methacrylates; urea aldehyde films; polyvinyl acetal; polyvinyl butyral. In some embodiments, the backing is a polymeric film comprising at least one of a polyolefin, polyester, or poly(vinyl chloride). In some embodiments, the backing comprises polyethylene-laminated cloth. In some embodiments, the polymeric film backing comprises at least one of monoaxially oriented polypropylene, biaxially oriented polypropylene, or polyethylene terephthalate.

In some embodiments, the backing of the tape of the present disclosure is a surface-treated polymeric film. Useful surface treatments include electrical discharge in the presence of a suitable reactive or non-reactive atmosphere (e.g., plasma, glow discharge, corona discharge, dielectric barrier discharge or atmospheric pressure discharge), ultraviolet light exposure, electron beam exposure, flame discharge, and scuffing. The surface treatment can be applied as the polymer film backing is being made or in a separate process. In some embodiments, the polymer film backing is surface-treated using corona discharge. An example of a useful corona discharge process is described in U.S. Pat. No. 5,972,176 (Kirk et al.).

In some embodiments, tape includes a low-adhesion backsize. Low-adhesion backsizes are known to one of ordinary skill in the art can be made from a variety of materials (e.g., a silicone, fluorochemical, or carbamate). Some examples of low-adhesion backsizes are described, for example, in U.S. Pat. No. 2,532,011 (Dahlquist), U.S. Pat. No. 2,607,711 (Hendricks), and U.S. Pat. No. 3,318,852 (Dixon).

A paper backing for the tape of the present disclosure can be any suitable paper, for example, crepe paper having a weight of about 20 to 40 pounds per ream of 3000 square feet. The paper can be saturated with an aqueous emulsion of rubbers, for example, a mixture of carboxylated rubber latexes (e.g., carboxylated nitrile, styrene butadiene, and optionally acrylic rubber latexes) in a variety of ratios, optionally including polyethylene glycol. Conventional additives such as pigments and antioxidants such as those described below can be included in the saturant. The aqueous saturant formulation may be 10% to 50% solids and may be applied to the paper at about 10% to 150% by weight, based on weight of latex solids and dry paper weight. The saturated paper is typically then dried and crosslinked at an elevated temperature up to about 180° C. A conventional release coating is typically applied to one face of the impregnated paper backing. An example of a release coating formulation includes a 10:90 mixture of one acrylate (e.g., available from Dow Chemical Co., Midland, Mich., under the trade designation “RHOPLEX”) and a second acrylate (e.g., available from BASF, Florham Park, N.J., under the trade designation “ACRONAL S504”), which also contains some nitrile and butadiene rubbers. The mixture can be applied as an emulsion of about 15% to 50% solids, after which, the tape is again dried. Other suitable release coatings include water-based polyurethane/acrylic dispersions such as those from Hitac Adhesives and Coatings, Santa Fe Springs, CA, USA, under the trade designations “HITAC RA-13W”, “HITAC RA-15W”, and “HITAC RA-42W”.

The tape of the present disclosure includes a PSA. The PSA includes an elastomer that is at least partially crosslinked. PSAs are generally known to possess the following desirable properties: (1) aggressive and permanent tack, (2) adherence with no more than finger pressure, (3) sufficient ability to hold onto an adherend, and (4) sufficient cohesive strength to be cleanly removable from the adherend. Materials that have been found to function well as PSAs are polymers designed and formulated to exhibit the requisite viscoelastic properties resulting in a desired balance of tack, peel adhesion, and shear holding power.

While PSAs are desirably cleanly removable from an adherend, clean removability can be challenging, particularly after aging at elevated temperatures. A lack of clean removability can be indicative of poor cohesive strength in the PSA and/or poor bonding of the PSA to the backing in a PSA tape.

Elastomers that may be crosslinked typically include carbon-carbon double bonds. Examples of useful unsaturated elastomers include natural rubber, synthetic polyisoprene, polybutadiene, styrene/butadiene rubber (SBR), styrene/isoprene/butadiene rubber, and acrylonitrile butadiene rubber. Various backbone geometries and connectivities may be present in these polymers. For polybutadiene and polyisoprene, a high amount of cis geometry may be desirable. In some embodiments, the elastomer comprises at least one of natural rubber, synthetic polyisoprene rubber, styrene/butadiene rubber, styrene/isoprene/butadiene rubber or acrylonitrile butadiene rubber. Combinations of two or more of these elastomers may be present in the composition, for example, natural rubber and SBR. In some embodiments, the elastomer is a hydrocarbon elastomer. In some embodiments, the elastomer comprises at least one of natural rubber or a copolymer of styrene with at least one of isoprene or butadiene. In some embodiments, the elastomer comprises a styrene/isoprene or styrene/isoprene/butadiene copolymer.

The term “PSA composition” as used herein generally includes the elastomer before it is at least partially crosslinked. In some embodiments, the PSA or PSA composition includes at least about 20 percent by weight and up to about 80 percent by weight of the elastomer(s), based on the total weight of the PSA or PSA composition. In some embodiments, the elastomer is present in a range from 80 to 30, 75 to 40, 70 to 30, 70 to 40, 70 to 45, or 65 to 45 percent by weight, based on the total weight of the PSA or PSA composition.

The PSA in the tape of the present disclosure includes sulfur. Sulfur refers to elemental sulfur. Sulfur is available in many forms such as powdered sulfur, precipitated sulfur, colloidal sulfur, insoluble sulfur, and highly dispersible sulfur and halogenated sulfurs such as sulfur monochloride and sulfur dichloride. Sulfur, for example, cyclic S₈, reacts with elastomers having carbon-carbon double bonds and forms crosslinks between polymer chains. The crosslinks include polysulfide bonds. The term “polysulfide bond” refers to sulfur-sulfur bonds and includes disulfide bonds. That is, the crosslinks between polymer chains can include —S—S—, —S—S—S—, —S—S—S—S—, —S—S—S—S—S—, and/or —S—S—S—S—S—S— polysulfide bonds, for example. Crosslinking an elastomer with sulfur is generally carried out by heating the elastomer in the presence of sulfur at an elevated temperature, for example, at least 160° F. (71° C.), at least 200° F. (93° C.), at least 250° F. (121° C.), 300° F. (149° C.), or above. The presence of polysulfide bonds in a crosslinked elastomer can be determined by infrared spectroscopy and other analytical techniques using methods known in the art.

In some embodiments, the sulfur is present in a range from 0.5 to 10, 1 to 10, 2 to 10, 3 to 10, 5 to 10, or 6 to 10 by weight, based on the weight of the elastomer and the sulfur in the PSA or PSA composition.

In some embodiments, the PSA or PSA composition further includes a vulcanization accelerator. A vulcanization accelerator is believed to break sulfur chains and lower the activation energy required for vulcanization. Examples of useful vulcanization accelerators include sulfenamide vulcanization accelerators (e.g., those made from mercaptobenzothiazole and a primary amine such as cyclohexylamine or tert-butylamine), thiourea vulcanization accelerators (e.g., ethylene thiourea), thiazole vulcanization accelerators (e.g., mercaptobenzothiazole, zinc-2-mercaptobenzothiazole, or 2-benzothiazolyl disulfide), dithiocarbamate vulcanization accelerators (e.g., zinc diethyldithiocarbamate and zinc dibutyldithiocarbamate), xanthogenic acid vulcanization accelerators, and thiuram vulcanization accelerators (e.g., tetramethylthiuram disulfide and tetraethylthiuram disulfide). A combination of different classes of vulcanization accelerators may be useful. Such compounds, when used, can be present in an amount from about 0.01 to 3 percent by weight based on the total weight of the PSA or PSA composition.

In some embodiments, the PSA further includes a vulcanization activator. Although there are no specific limitations on the type of the vulcanization activator, poly(ethylene glycol), stearic acid, zinc oxide, another metal oxide, or another metal salt can be useful. While this disclosure is not intended to be bound by theory, it is believed that in the process of vulcanization, the zinc oxide or other metal salt activates the vulcanization accelerators described above. In some embodiments, the combination of stearic acid and zinc oxide or another metal oxide provides a salt that is more elastomer-soluble that activates the vulcanization accelerators. Also, poly(ethylene glycol), which may have any useful molecular weight (e.g., in a range from 200 grams per mole to 8000 grams per mole), is typically compatible with elastomers and may prevent adsorption of the vulcanization accelerators by other components of the elastomer composition (e.g., glass bubbles). Vulcanization activators, when used, can be present in an amount from about 0.01 to 3 percent by weight based on the total weight of the PSA or PSA composition. In some embodiments, the PSA includes zinc oxide.

In the tape of the present disclosure, the PSA includes a tackifying resin. Tackifying resins generally refer to materials that are compatible with the elastomer and have a number average molecular weight of up to 10,000 grams per mole. Useful tackifying resins can have a softening point of at least 70° C. as determined using a ring and ball apparatus and a glass transition temperature of at least −30° C. as measured by differential scanning calorimetry. The tackifying resins are typically amorphous. In some embodiments, the number average molecular weight of the tackifying resin is up to about 5000 grams/mole, 4000 grams/mole, 2500 grams/mole, 2000 grams/mole, or 1500 grams/mole. In some embodiments, the number average molecular weight is in the range of 200 to 5000 gram/mole, in the range of 200 to 4000 grams/mole, in the range of 200 to 2000 grams/mole, or in the range of 200 to 1500 gram/mole. Number average molecular weights are determined using gel permeation chromatography according to methods known to a person skilled in the art. In some embodiments, the tackifying resin is a hydrocarbon tackifying resin.

In some embodiments, the tackifying resin comprises at least one of a rosin acid, a rosin ester, an aliphatic hydrocarbon resin (e.g., those based on cis- or trans-piperylene, isoprene, 2-methyl-but-2-ene, cyclopentadiene, dicyclopentadiene, or combinations thereof), an aromatic resin (e.g., those based on styrene, α-methyl styrene, methyl indene, indene, coumarone, or combinations thereof), or a mixed aliphatic-aromatic hydrocarbon resin. The aromatic hydrocarbon resins may be C9-type petroleum resins obtained by copolymerizing a C9 fraction produced by thermal decomposition of petroleum naphtha, and aliphatic hydrocarbon resins may be C5-type petroleum resins obtained by copolymerizing a C5 fraction produced by thermal decomposition of petroleum naphtha. Mixed aliphatic/aromatic resins may be C5/C9-type petroleum resins obtained by polymerizing a combination of a C5 fraction and C9 fraction produced by thermal decomposition of petroleum naphtha. Any of these tackifying resins may be hydrogenated (e.g., partially or completely). The term rosin, as employed herein, includes natural rosin, refined or unrefined (refined rosin will usually contain, by weight, about 90% of rosin acids and about 10% of inert material), such as natural wood rosin, natural gum rosin, and tall oil rosin; modified rosin, refined or unrefined, such as disproportionated rosin, hydrogenated rosin, and polymerized rosin; and the pure or substantially pure acids, of which rosin is comprised, alone or in admixture.

In some embodiments of the tape of the present disclosure, the PSA includes a metal rosinate. A metal rosinate is sometimes referred to in the art as a metal resinate. The terms are considered interchangeable. The metal rosinate can be salt of any of the rosins described above. The metal rosinate useful in the PSA composition generally comprises a salt of an acid having the molecular formula C₁₉H₂₉COOH, in some embodiments, at least one of abietic acid or pimaric acid. In some embodiments, the metal rosinate comprises a salt of at least one of abietic acid, neoabietic acid, palustric acid, levopimaric acid, pimaric acid, or an isopimaric acid. In some embodiments, the metal rosinate comprises dehydro- or hydrogenated rosin acids, for example, dehydroabietic acid, dihydroabietic acid, and tetrahydroabietic acid.

Examples of metal cations in the metal rosinate useful in the PSA and PSA composition include aluminum (Al), calcium (Ca), magnesium (Mg), zinc (Zn), barium (Ba), lithium (Li), sodium (Na), and potassium (K). In some embodiments, the metal rosinate comprises at least one of zinc rosinate, calcium rosinate, or magnesium rosinate. In some embodiments, the metal rosinate comprises zinc rosinate. Metal rosinates are commercially available from a variety of sources or can be prepared by treating a commercially available rosin with a metal salt (e.g., zinc oxide or calcium hydroxide) using techniques known in the art.

In some embodiments, the metal rosinate is present in the PSA or PSA composition in a range from two percent to 50 percent by weight, based on the total weight of the PSA or PSA composition. In some embodiments, the metal rosinate is present in the composition in an amount of at least 2, 3, or 5 percent by weight, based on the total weight of the PSA or PSA composition. In some embodiments, the metal rosinate can be used as the only tackifying resin in the PSA. In some embodiments, a combination of metal rosinate and one or more other tackifying resins (e.g., an aliphatic hydrocarbon resin, an aromatic resin, or a mixed aliphatic-aromatic hydrocarbon resin) is used to tackify the PSA. While the present disclosure is not intended to be bound by theory, it is believed that a metal rosinate can serve also as a vulcanization activator as described above.

The amount of tackifying resin, which can include a combination of tackifying resins such as any of those described above, in the PSA or PSA composition can be any amount sufficient such that the PSA is tacky. In some embodiments, the PSA or PSA composition includes at least about 15 percent by weight and up to about 75 percent by weight of the tackifying resin, based on the total weight of the composition. In some embodiments, the tackifying resin is present in a range from 15 to 70, 15 to 60, 20 to 60, 20 to 50, 20 to 45, or 15 to 35 percent by weight, based on the total weight of the PSA or PSA composition.

Some suitable tackifying resins are commercially available under the trade designations “TACOLYN” from Eastman Chemical, Kingsport, TN, and “AQUATAC” from Kraton Corporation, Houston, TX.

A number of adjuvants may also be useful in the PSA. Examples of such adjuvants include antioxidants, such as hindered phenols, amines, sulfur and phosphorous hydroperoxide decomposers, and butylated hydroxytoluene (BHT)) and inorganic fillers such as talc, zinc oxide, titanium dioxide, aluminum oxide, and silica. Useful commercially available antioxidants include those available from BASF, Florham Park, NJ, under the trade designations “IRGANOX” and “IRGAFOS” and those available from Songwon Ind. Co, Ulsan, Korea, under the trade designations “SONGNOX”. Compositions according to the present disclosure can also include at least one of pigments, dyes, ultraviolet absorbers, hindered amine light stabilizers, and heat stabilizers, if desired. When present, typically the antioxidant is present in the PSA or PSA composition in an amount of 0.1 to 5 parts by weight per 100 parts by weight elastomer, and the inorganic filler can be present in the PSA or PSA composition in an amount of up to 50 parts by weight per 100 parts by weight of elastomer.

The process of making the tape according to the present disclosure includes applying an aqueous dispersion of the elastomer, the tackifying resin, and the sulfur to the backing and drying the aqueous dispersion to provide the PSA on the backing. The present disclosure further provides an aqueous dispersion comprising an elastomer, a tackifying resin, and sulfur. An aqueous dispersion includes water. One of ordinary skill in the art appreciates that a dispersion is a system in which discrete particles of one material are dispersed in a continuous phase of another material. The two phases may be in the same or different states of matter. As described above, sulfur refers to elemental sulfur. Sulfur is available in many forms such as powdered sulfur, precipitated sulfur, colloidal sulfur, insoluble sulfur, and highly dispersible sulfur and halogenated sulfurs such as sulfur monochloride and sulfur dichloride. Optionally the dispersion further includes at least one of a vulcanization accelerator, a vulcanization activator, or an antioxidant. Aqueous dispersions of rubbers, aqueous dispersions of tackifying resins, and aqueous dispersions of sulfur are commercially available from a variety of sources. For example, latexes of natural rubber, synthetic polyisoprene rubber, styrene/butadiene rubber, and acrylonitrile butadiene and aqueous dispersions of rosin acids, rosin esters, C5 aliphatic hydrocarbon resins, C9 aromatic resins, and mixed aliphatic-aromatic hydrocarbon resins can all be obtained commercially. A useful dispersion of sulfur, zinc oxide, zinc-2-mercaptobenzothiazole, and zinc diethyl dithiocarbamate is commercially available from Tiarco Chemical, Dalton, Ga., under the trade designation “OCTOCURE 590”. In some embodiments, the process for making the tape further comprises combining an elastomer aqueous dispersion, a tackifying resin aqueous dispersion, and a sulfur aqueous dispersion to provide the aqueous dispersion. Each of these dispersions can contain, for example, in a range from 10 to 80 percent, 20 to 80 percent, or 40 to 70 percent by weight solids in the aqueous dispersion. Drying can be carried out at room temperature or at an elevated temperature, e.g., about 70° C. to 125° C., based on the backing substrate and web line speed, for example, to remove water. Drying can also be carried out under vacuum.

In some embodiments of the aqueous dispersion and the process of making the tape of the present disclosure, the elastomer is present in the aqueous dispersion in a range from 80 to 20, 80 to 30, 75 to 40, 70 to 30, 70 to 40, 70 to 45, or 65 to 45 percent by weight, based on the total weight of solids in the aqueous dispersion (that is, excluding water). In some embodiments, the tackifying resin is present in the dispersion in a range from 15 to 75, 15 to 70, 15 to 60, 20 to 60, 20 to 50, 20 to 45, or 15 to 35 percent by weight, based on the total weight of solids in the aqueous dispersion (that is, excluding water). In some embodiments, the sulfur is present in a range from 0.5 to 10, 1 to 10, 2 to 10, 3 to 10, 5 to 10, or 6 to 10 percent by weight, based on the weight of the elastomer and the sulfur in the aqueous dispersion (excluding water). In some embodiments, the vulcanization accelerator is present in a range from 0.01 to 3 percent by weight, based on the total weight of solids in the aqueous dispersion (that is, excluding water). In some embodiments, the vulcanization activator is present in a range from 0.01 to 3 percent by weight, based on the total weight of solids in the aqueous dispersion (that is, excluding water).

In some embodiments of the aqueous dispersion and the process of making the tape of the present disclosure, the aqueous dispersion further comprises a surfactant. Surfactants can be useful, for example, as emulsifiers, dispersing agents, and wetting agents. Suitable surfactants include anionic surfactants (e.g., sulfates, sulfonates, phosphates, carboxylates, and sulfates of polyethoxylated derivatives of straight or branched chain aliphatic alcohols and carboxylic acids), cationic surfactants (e.g., quaternary ammonium salts), amphoteric surfactants (e.g., sultaines, betaines, and sulfobetaines), and nonionic surfactants (e.g., alkyl polyglucosides (e.g., obtained under the trade designation “APG 325”, from BASF SE, Ludwigshafen, Germany), alkyl glucosides (e.g., blend of decyl and undecyl glucoside), fatty amine ethoxylates, fatty alcohol ethoxylates, fatty acid alkanolamides, castor oil ethoxylates, alcohol ethoxylates/propoxylates, and combinations thereof). In some embodiments, the surfactant is a nonionic surfactant. In some embodiments, a combination of surfactants is present in the aqueous dispersion and/or PSA. In some embodiments, a combination of anionic and nonionic surfactants is present in the aqueous dispersion and/or PSA.

A surfactant useful as a dispersant may be present in the aqueous dispersion in any suitable amount to keep the elastomer, tackifying resin, and sulfur particles dispersed in the water. In some embodiments, the dispersant is present in a range from 0.5% to 20% by weight, 0.5% to 15% by weight, 1% to 10% by weight, 0.01% to 2% by weight, 0.05% to 0.5% by weight, based on the weight of the solids in the aqueous dispersion (that is, excluding water). A surfactant useful as a wetting agent may be present in the aqueous dispersion in any suitable amount to promote wetting of the aqueous dispersion on the backing. In some embodiments, the wetting agent is present in a range from 0.01% to 2% by weight, 0.05% to 0.5% by weight, or about 0.1% by weight, based on the total weight of the aqueous dispersion.

After removing water from the aqueous dispersion, a surfactant may still be present in the PSA and may be detectable in the PSA using standard spectroscopic and other analytical techniques using methods known in the art. The presence of surfactants or a combination of surfactants in the PSA may be a useful indication that the PSA was applied on the backing from an aqueous dispersion.

The aqueous dispersion may be applied to the backing using a variety of techniques (e.g., rod coating, knife coating, bar coating, curtain coating, gravure coating, roll coating, slot or die coating, dip coating, and spray coating). After drying, in some embodiments, the PSA is present on the backing in a range from 20 grams per square meter (gsm) to 150 gsm. Useful amounts of PSA can be, for example, 20 gsm to 60 gsm, 20 gsm to 40 gsm, or 40 gsm to 60 gsm for paper and polymer film backings. For polymer/cloth laminates, useful amounts of PSA can be, for example, 80 gsm to 150 gsm.

In some embodiments, the aqueous dispersion is substantially free of volatile organic solvent. In some embodiments, the PSA is substantially free of volatile organic solvent. Volatile organic solvents are typically those have a boiling point of up to 150° C. at atmospheric pressure. Examples of volatile organic solvents include aliphatic and alicyclic hydrocarbons (e.g., hexane, heptane, and cyclohexane), aromatic solvents (e.g., benzene, toluene, and xylene), ethers (e.g., diethyl ether, glyme, diglyme, diisopropyl ether, and tetrahydrofuran), alcohols (e.g., ethanol and isopropyl alcohol), ketones (e.g., methyl ethyl ketone and methyl isobutyl ketone), sulfoxides (e.g., dimethyl sulfoxide), amides (e.g., N,N-dimethylformamide, N,N dimethylacetamide, and N-methyl-2-pyrrolidone), halogenated solvents (e.g., methylchloroform, 1,1,2-trichloro-1,2,2-trifluoroethane, trichloroethylene, and trifluorotoluene), and mixtures thereof. “Substantially free of volatile organic solvent” can mean that volatile organic solvent may be present (e.g., from a previous synthetic step or in a commercially available component) in an amount of up to 2.5 (in some embodiments, up to 2, 1, 0.5, 0.1, 0.05, or 0.01) percent by weight, based on the total weight of the aqueous dispersion or PSA. “Substantially free” can also mean that the aqueous dispersion or PSA is free of volatile organic solvent.

In some embodiments of the tape and process of the present disclosure, the elastomer is at least partially crosslinked by exposure to radiation, such as electron beam or ultraviolet radiation. Crosslinking may be carried out in-line with a coating operation described above or may occur as a separate process. In some embodiments, crosslinking is carried out after the PSA composition is disposed on a backing. The degree of crosslinking achieved is a matter of choice and is dependent upon various factors such as the end product desired, the elastomer used, and the thickness of the adhesive layer. Techniques for achieving crosslinking via exposure to radiation are known to those of skill in the art.

In embodiments in which the polymeric film backing is radiation degradable (e.g., vinyl films, cellulose films, polypropylene films, and polyfluoroethylene films), it may be useful to irradiate the composition on the polymeric film backing using a narrow voltage range as described in U.S. Pat. No. 5,266,400 (Yarusso et al.). Control of the voltage provides adequate uniformity of adhesive crosslinking through the thickness thereof while limiting backing damage or degradation to acceptable levels.

Crosslinking (e.g., using sulfur and/or radiation) can enhance, for example, the cohesive strength of the PSA in the tape of the present disclosure. In some embodiments, the elastomer is crosslinked to the point where at least 20% by weight of the elastomer is insoluble by the following gel content evaluation. Gel content is determined by soaking a sample of the PSA in toluene for 24 hours to extract the portion of the adhesive that is not crosslinked, determining the amount of gelled elastomer in the extracted sample, and dividing the amount of gelled elastomer by the amount of elastomer in the PSA composition.

The presence of sulfur in the PSA provides several beneficial effects. Sulfur is believed to react with the elastomer at a relatively low temperature, such as 200° F. (93° C.) or lower, which can allow the tape of the present disclosure to be cleanly removable from surfaces at a variety of temperatures, such as below 280° F. (138° C.) as well as higher temperatures such as 300° F. to 360° F. (150° C. to 182° C.). As shown in the Examples, below, in a comparison of Examples 1 to 4 with Control Example A and Examples 5 to 9 with Control Example B, the presence of sulfur can provide increased shear adhesion to stainless steel.

In some embodiments, the tape of the present disclosure is cleanly removable from stainless steel at a temperature in a range from room temperature to 150° C. after exposure to a temperature of at least 300° F. (150° C.) for at least 30 minutes. As shown in Table 3, Examples 3 and 4, which included sulfur in a natural rubber-based PSA, were cleanly removed from stainless steel after exposure to 300° F. (150° C.) while Control Example A, including no sulfur, was not. Similarly, Examples 6 to 9, which included sulfur in an SBR-based PSA, were cleanly removed from stainless steel after exposure to 300° F. (150° C.) while Control Example B, including no sulfur, was not. The clean removal of the tape of the present disclosure from substrates after exposure to high temperature suggests that the cohesive (internal) strength of the overall tape construction is greater than the adhesive strength between the tape and the substrate. Such cohesive strength is indicative of good bonding between materials in the tape construction and good crosslinking of the PSA, which counteracts thermal degradation of the elastomer. Clean removal of tape from substrates refers to having no adhesive transfer or residue when evaluated according to the Adhesive Transfer Test described in the Examples, below.

The amount of sulfur in the PSA necessary to make the tape of the present disclosure cleanly removable from a surface (e.g., glass, metal, or a painted surface) at a temperature in a range from room temperature to 150° C. after exposure to a temperature of at least 300° F. (150° C.) for at least 30 minutes can vary depending on the type of elastomer used and the amount of elastomer in the composition relative to the other components. For example, as shown in the Examples below, less sulfur may be needed in an SBR-based PSA than a natural rubber-based PSA to make the PSA cleanly removable after exposure to a temperature of at least 300° F. (150° C.) for at least 30 minutes. Less sulfur may also be needed in a PSA that includes a relatively higher ratio of elastomer to tackifying resin. In some embodiments, the sulfur is present in a range from 1 to 10, 2 to 10, 3 to 10, 5 to 10, or 6 to 10 percent by weight, based on the weight of the elastomer and the sulfur in the PSA or PSA composition.

The tape of the present disclosure may be useful for a variety of different applications that require the tape to be exposed to a variety of different temperatures or a wide range of temperature. The tape of the present disclosure can be useful, for example, as a masking tape or for any other use that requires high temperature holding power and clean removal. The present disclosure provides of method of using the tape of the present disclosure. The method includes applying the tape to a surface and exposing the surface to a temperature of at least 150° C. The surface may be a component of an automobile, airplane, or marine vessel, for example. In some embodiments, the surface comprises at least one of glass, metal (e.g., stainless steel or aluminum), or a painted surface. The painted surface can include a painted metal (e.g., stainless steel or aluminum) surface, a painted polymer surface, or a painted composite surface. A composite surface may be made from any two or more constituent materials with different physical or chemical properties. Some examples of useful composites include fiber-reinforced polymers (e.g., carbon fiber reinforced epoxies and glass-reinforced plastic), metal matrix compositions, and ceramic matrix composites.

### Some Embodiments of the Disclosure

In a first embodiment, the present disclosure provides tape comprising:
a backing; and
a pressure-sensitive adhesive applied from an aqueous dispersion on the backing, the pressure-sensitive adhesive comprising:
   an at least partially crosslinked elastomer;
   a tackifying resin; and
   sulfur.

In a second embodiment, the present disclosure provides the tape of the first embodiment, wherein the at least partially crosslinked elastomer comprises at least one of natural rubber, synthetic polyisoprene rubber, styrene-butadiene rubber, styrene-isoprene-butadiene rubber, or acrylonitrile butadiene rubber.

In a third embodiment, the present disclosure provides the tape of the first or second embodiment, wherein the at least partially crosslinked elastomer is a hydrocarbon elastomer.

In a fourth embodiment, the present disclosure provides the tape of any one of the first to third embodiments, wherein the tackifying resin comprises at least one of a rosin acid, a rosin ester, a C5 aliphatic hydrocarbon resin, a C9 aromatic resin, or a mixed aliphatic-aromatic hydrocarbon resin.

In a fifth embodiment, the present disclosure provides the tape of the fourth embodiment, wherein the tackifying resin comprises at least one of a rosin acid or a rosin ester.

In a sixth embodiment, the present disclosure provides the tape of any one of the first to fifth embodiments, wherein the tackifying resin is present in an amount of at least 15 percent by weight, based on the total weight of the PSA.

In a seventh embodiment, the present disclosure provides the tape of any one of the first to sixth embodiments, wherein the pressure-sensitive adhesive further comprises at least one of a vulcanization accelerator or a vulcanization activator.

In an eighth embodiment, the present disclosure provides the tape of any one of the first to seventh embodiments, wherein the pressure-sensitive adhesive further comprises an antioxidant.

In a ninth embodiment, the present disclosure provides the tape of any one of the first to eighth embodiments, wherein the pressure-sensitive adhesive further comprises a surfactant.

In a tenth embodiment, the present disclosure provides the tape of the ninth embodiment, wherein the pressure-sensitive adhesive further comprises more than one surfactant.

In an eleventh embodiment, the present disclosure provides the tape of any one of the first to tenth embodiments, wherein the pressure-sensitive adhesive is present on the backing in a range from 20 grams per square meter to 150 grams per square meter.

In a twelfth embodiment, the present disclosure provides the tape of any one of the first to eleventh embodiments, wherein the at least partially crosslinked elastomer is at least partially crosslinked with polysulfide bonds.

In a thirteenth embodiment, the present disclosure provides the tape of any one of the first to twelfth embodiments, wherein the backing comprises paper, polyester, poly(vinyl chloride), polypropylene, or polyethylene laminated cloth.

In a fourteenth embodiment, the present disclosure provides the tape of any one of the first to thirteenth embodiments, wherein the tape is cleanly removable at a temperature in a range from room temperature to 150° C. from a surface after exposure to a temperature of at least 150° C. for at least 30 minutes.

In a fifteenth embodiment, the present disclosure provides the tape of the fourteenth embodiment, wherein the surface comprises at least one of glass, stainless steel, or a painted surface.

In a sixteenth embodiment, the present disclosure provides the tape of the fifteenth embodiment, wherein the surface is a component of an automobile, airplane, or marine vessel.

In a seventeenth embodiment, the present disclosure provides the tape of any one of the first to the sixteenth embodiments, wherein the pressure-sensitive adhesive is substantially free of a phenolic curative, meaning having not more than 1, 0.5, 0.1, 0.05, 0.01, or 0 percent by weight phenolic curative, based on the total weight of the pressure-sensitive adhesive.

In an eighteenth embodiment, the present disclosure provides the tape of any one of the first to the seventeenth embodiments, wherein the backing has a first face and a second face opposite the first face, wherein the pressure-sensitive is on the first face of the backing, and wherein the tape further comprises a low-adhesion backsize on the second face of the backing.

In a nineteenth embodiment, the present disclosure provides a process of making the tape of any one of the first to the eighteenth embodiments, the process comprising:
applying an aqueous dispersion of an elastomer, the tackifying resin, and the sulfur to the backing; and
drying the aqueous dispersion to provide the pressure-sensitive adhesive on the backing.

In a twentieth embodiment, the present disclosure provides a process of making a tape, the process comprising:
applying an aqueous dispersion of an elastomer, a tackifying resin, and sulfur to a backing; and
drying the aqueous dispersion to provide a pressure-sensitive adhesive on the backing.

In a twenty-first embodiment, the present disclosure provides an aqueous dispersion comprising an elastomer, a tackifying resin, and sulfur.

In a twenty-second embodiment, the present disclosure provides the process of the twentieth or the aqueous dispersion of the twenty-first embodiment, wherein the elastomer comprises at least one of natural rubber, synthetic polyisoprene rubber, styrene-butadiene rubber, styrene-isoprene-butadiene rubber, or acrylonitrile butadiene rubber.

In a twenty-third embodiment, the present disclosure provides the process or aqueous dispersion of any one of the twentieth to twenty-second embodiments, wherein the tackifying resin comprises at least one of a rosin acid, a rosin ester, a C5 aliphatic hydrocarbon resin, a C9 aromatic resin, or a mixed aliphatic-aromatic hydrocarbon resin.

In a twenty-fourth embodiment, the present disclosure provides the process of any one of the twentieth, twenty-second, or twenty-third embodiments, wherein the backing comprises at least one of paper, polyester, poly(vinyl chloride), polypropylene, or polyethylene laminated cloth.

In a twenty-fifth embodiment, the present disclosure provides the process of any one of the nineteenth, twentieth, or twenty-second to twenty-fourth embodiments, further comprising combining an elastomer aqueous dispersion, a tackifying resin aqueous dispersion, and a sulfur aqueous dispersion to provide the aqueous dispersion.

In a twenty-sixth embodiment, the present disclosure provides the process or aqueous dispersion of any one of the nineteenth to twenty-fifth embodiments, wherein the aqueous dispersion further comprises at least one of a vulcanization accelerator, a vulcanization activator, or an antioxidant.

In a twenty-seventh embodiment, the present disclosure provides the process or aqueous dispersion of any one of the nineteenth to twenty-sixth embodiments, wherein the sulfur is present in a range from one percent to ten percent by weight, based on the weight of the elastomer and the sulfur in the aqueous dispersion.

In a twenty-eighth embodiment, the present disclosure provides the process of any one of the nineteenth, twentieth, or twenty-second to twenty-seventh embodiments, further comprising exposing the tape to radiation to partially crosslink at least the elastomer.

In a twenty-ninth embodiment, the present disclosure provides the process of the twenty-eighth embodiment, wherein the radiation is electron beam radiation, ultraviolet light, or a combination thereof.

In a thirtieth embodiment, the present disclosure provides the process of any one of the nineteenth, twentieth, or twenty-second to twenty-ninth embodiments, further comprising heating the tape to partially crosslink the elastomer with polysulfide bonds.

In a thirty-first embodiment, the present disclosure provides the process or aqueous dispersion of any one of the nineteenth to thirtieth embodiments, wherein the aqueous dispersion is substantially free of volatile organic solvent.

In a thirty-second embodiment, the present disclosure provides the process ofany one of the nineteenth, twentieth, or twenty-second to thirty-first embodiments, wherein the pressure-sensitive adhesive is substantially free of volatile organic solvent.

In a thirty-third embodiment, the present disclosure provides a process for using the tape ofany one of the first to eighteenth embodiments, the process comprising applying the tape to a surface and exposing the surface to a temperature of at least 150° C.

In a thirty-fourth embodiment, the present disclosure provides the use of the tape ofany one of the first to eighteenth embodiments or made by the process ofany one of the nineteenth to thirty-second embodiments at a temperature of at least 150° C.

Embodiments of the compositions and methods disclosed herein are further illustrated by the following examples, but the particular materials and amounts thereof recited in these examples, as well as other conditions and details, should not be construed to unduly limit this invention.

### EXAMPLES

Unless otherwise noted, all parts, percentages, ratios, etc. in the Examples and the rest of the specification are by weight. The following abbreviations are used in this section: kg=kilogram, centimeter=cm, mm=millimeter, in.=inches, ° C.=degrees Celsius, ° F.=degrees Fahrenheit, RH=relative humidity, lb=pound, sec=second, oz=ounces, and min=minutes.

TABLE 1
Materials List

| Abbreviation | Description |
|---|---|
| NR Latex | Natural rubber latex (61.6% solids), obtained under the trade designation |
| | “ALCANTEX H.A.” from Alcan Rubber and Chemical, New York, NY |
| Rosin Dispersion | Rosin dispersion (60% solids), obtained under the trade designation |
| | “AQUATAC 6085” from Kraton Corporation, Houston, TX |
| Sulfur Dispersion | Sulfur dispersion (60% solids), obtained under the trade designation |
| | “OCTOCURE 590” from Tiarco Chemical, Dalton, GA |
| SBR Dispersion | Dispersion of copolymer of styrene and butadiene, (approximately 51% |
| | solids), obtained under the trade designation “BUTOFAN NS 222” from |
| | BASF, Ludwigshafen, Germany |
| S-51 | Washi backing, obtained from KJ Specialty Paper Co. Ltd., Fuji, Shizuoka |
| | Prefecture, Japan |
| Loparex liner | Paper release liner, obtained from Loparex LLC, Cary, NC |

### Test Methods

### Adhesion to Glass Test

Tape sample strips measuring 0.5-in.×13-in. (1.27-cm by 33-cm) were acclimated in a controlled temperature environment (73.4+/−3.6° F. [23+/−2° C.], 50+/−5% RH) before starting the test. The peel tester (IMASS SP200, IMASS Inc., Accord, MA) parameters were set to run at average time of 5 seconds and testing speed of 90-in./min (229-cm/min). The 6-in.×12-in. (15.24-cm by 30.48-cm) black painted glass panel (Soda Lime Glass obtained from Northwestern Glass Fab, Fridley, MN) was secured to the peel tester platen. The glass panel was painted black using an acrylic lacquer spray paint on the “wire” side of the glass panel, not on the testing side. The “wire” side will glow when put under a black light. The peel tester was then calibrated.

The black painted glass panel was cleaned with a quarter size quantity of diacetone alcohol and then wiped off with a “KIMWIPES” cleaning tissue. An additional “KIMWIPES” cleaning tissue was used to wipe the glass plate again, removing any remaining diacetone alcohol and making sure the glass surface looked clean. Finally, three N-heptane washes were used, using a “KIMWIPES” cleaning tissue to wipe off the N-heptane from the glass plate in between each wash.

The Loparex liner was removed from a tape sample strip. The ends of the sample strip were then held in each hand. The left end of the sample strip was then touched to the left end of the black painted glass plate, and the right end of the sample strip was then touched to the right end of the glass plate. A rubber roller [per standard ASTM/PSTC 4.5-lb (2.0-kg)] was then placed at the left end of the glass plate, sitting the rubber roller on top of the tape sample.

The peel tester platen was then engaged to move at 90 in./min (229 cm/min), with the left hand guiding the rubber roller as it rolled down the tape sample onto the black painted glass panel. Once the peel tester platen stopped, the 4.5 lb (2-kg) rubber roller was removed from the tape sample and the platen returned to starting position. The left end of the tape sample was then attached to the wired leader with a stirrup and removed nearly all the slack by adjusting the platen. When platen stopped, the average force was measured and recorded. Three sample strips were measured for each sample and the average adhesion to glass and deviation were reported.

### Adhesion to Steel Test

Tape sample strips measuring 0.5-in.×13-in. (1.27-cm by 33-cm) were acclimated in a controlled temperature environment (73.4+/−3.6° F. [23+/−2° C.], 50+/−5% RH) before starting the test. The peel tester (INSTRON Model, Model 3343Q8711 Norwood, MA) parameters were set to run at a crosshead speed of 12-in./min (30.5-cm/min), a jaw separation of 5-in. (12.7-cm), full-scale load of 100-oz (4.8-kg), a peel distance of 5-in. (12.7-cm), and a peel force average distance set to measure between 2-in. (5.1-cm) and 4-in. (10.2-cm) of sample length. The peel tester was then calibrated.

A 2-in. (5.1-cm) by 6-in. (15.24-cm) stainless-steel panel Type 304 as prescribed in ASTM A666 with a bright annealed finish, 18-gauge (1.2-mm) thickness, and a polish finish on one side with a surface roughness height of 1.5+/−0.5 micro inches (0.038+/0.013 micrometers) obtained from ChemInstruments, Fairfield, Ohio) was cleaned with a quarter size quantity of diacetone alcohol and then wiped off with “KIMWIPES” cleaning tissue. An additional “KIMWIPES” cleaning tissue was used to wipe the stainless-steel panel again, removing any remaining diacetone alcohol making sure the surface looked clean. Finally, three N-heptane washes were used, using a “KIMWIPES” cleaning tissue to wipe off the N-heptane from the stainless-steel plate in between each wash.

The Loparex liner was removed from the tape sample strip. The ends of the tape sample were then held in each hand. The sample was positioned above the stainless-steel panel so the long edge of the sample was parallel to the long side of the panel and so the specimen was centered in the middle of the vertical direction of the panel. The tape sample was then laid onto the stainless-steel panel, making sure there was 1-in. (2.54-cm) of the tape sample extending from the top of the panel and that the remaining 7-in. (17.8-cm) of the tape sample were extended from the bottom of the panel.

The tape sample was then rolled onto the stainless-steel panel using a 4.5-lb (2-kg) rubber roller. The rubber roller was moved up and down the panel twice in each direction at approximately 24 in./min (61 cm/min) ensuring only to allow the weight of the roller to apply the force to the tape sample. A razor blade was used to cut, along the edge of the top of the panel, the 1 in. (2.54 cm) of the tape sample that was extended from the top of the panel. The extended 7-in. (17.8-cm) tape sample was held from the bottom of the panel, and the tape sample was peeled back by hand 1-in. (2.54 cm) from the bottom edge of the panel. The bottom end of the stainless-steel panel was clamped into the lower jaw of the peel tester. The top end of the 7-in. (17.8-cm) tape sample extending from the bottom of the panel was clamped into the upper jaw of the peel tester. The crosshead peel test was carried out on the peel tester, and the average peel force value and the amount of transfer were recorded.

### Shear to Steel Test

Tape sample strips measuring 0.5-in.×13-in. (1.27-cm by 33-cm) were acclimated in a controlled temperature environment (73.4+/−3.6° F. [23+/−2° C.], 50+/−5% RH) before starting the test. A 2-in. (5.08-cm)×3-in. (7.62-cm) stainless-steel panel was cleaned with a quarter size quantity of diacetone alcohol and then wiped off with “KIMWIPES” cleaning tissue. An additional “KIMWIPES” cleaning tissue was used to wipe the stainless-steel panel again, removing any remaining diacetone alcohol making sure the glass surface looked clean. Finally, three n-heptane washes were used, using a “KIMWIPES” cleaning tissue to wipe off the n-heptane from the stainless-steel plate in between each wash.

The Loparex liner was removed from a tape sample strip. The ends of the tape sample were then held in each hand. The sample was positioned above the stainless-steel panel so the long edge of the sample was parallel to the short sides of the panel and so the specimen was centered in the middle of the horizontal direction of the panel. The tape sample was then laid onto the stainless-steel panel, making sure 2-in. (5.08-cm) of the tape sample were extended from the bottom of the panel. Rolled down tape sample to the stainless-steel panel twice in each direction (up and down the panel) at 24-in./min (61-cm/min) using a 4.5-lb (2-kg) rubber roller. A metal hook was attached to the leading edge of the tape sample. The other end of the sample was trimmed at 0.5-in. (1.27-cm) from the bottom edge of the stainless-steel panel so that a 0.5-in. (1.27 cm)×0.5-in. (1.27 cm) area of the tape sample remained bonded to the panel.

A shear test stand with timers was used to hold the stainless-steel test panel to run the shear test. The stainless-steel panel was placed vertically in the shear test stand, so the metal hook hung down. A 1-kg (2.2-lb) weight was attached to the hook and the timer was started. The time required (in minutes) for the tape sample to fall off was recorded. Three sample strips were measured for each sample and the average shear to steel and deviation were reported.

### Adhesive Transfer Test

The level of adhesive transfer to a stainless-steel panel was measured after tape samples were subjected to a bake cycle and the tape samples were partially removed at 149° F. (65° C.) and then completely removed at room temperature. The tape samples were tested at an oven temperature of 302° F. (150° C.).

A 2-in. (5.1-cm) by 6-in. (15.24-cm) stainless-steel panel Type 304 as prescribed in ASTM A666 with a bright annealed finish, 18-gauge (1.2-mm) thickness, and a polish finish on one side with a surface roughness height of 1.5+/−0.5 micro inches (0.038+/0.013 micrometers) obtained from ChemInstruments, Fairfield, Ohio) was cleaned with a quarter size quantity of diacetone alcohol and then wiped off with “KIMWIPES” cleaning tissue. An additional “KIMWIPES” cleaning tissue was used to wipe the stainless-steel panel again, removing any remaining diacetone alcohol making sure the surface looked clean. Finally, 3 N-heptane washes were used, using a “KIMWIPES” cleaning tissue to wipe off the N-heptane from the stainless-steel plate in between each wash.

Tape sample strips measuring 0.5-in.×13-in. (1.27-cm by 33-cm) were used in the adhesive transfer test. After removing the Loparex liner, the 3-inch-long tape sample was applied, adhesive side down, parallel to the short side edge of the stainless-steel panel and at least 0.25-in. (0.64-cm) to the left of the edge. A 2-in. (5.1-cm) tab was left beyond the bottom edge of the panel for handling. All tape samples were applied maintaining a minimum 0.25-in. (0.64-cm) spacing between tape samples or from the edge of the panel. Each tape sample was rolled down with two back-and-forth passes of a hand operated 4.5-lb (2-kg) rubber covered roller at a roll down rate of approximately 2-in./sec (5.1-cm/sec).

Panels were placed in a circulating air type electric oven capable of maintaining from 150 to 360° F. (65.6 to 182° C.)+/−5° F. (Despatch LFD series Oven, Model: LFD2-11-3, Despatch Industries, Minneapolis, Minn.). The panels were allowed to bake for 30+/−2 min. at 302° F. (150° C.). At the 30-min. time mark, the panels were removed and set on a table using a gloved hand. An IR gun was used to monitor temperature of each panel until the reading indicated reaching 149° F. (65° C.). Once that was achieved, the panels were positioned vertically and each tape sample was removed, one at a time, to the marked line, using an approximate 90-degree removal angle at a rate of 2 in./sec (5.08 cm/sec). The panels were then allowed to continue cooling until they reached room temperature (approximately 15 min). Remaining parts of each tape sample were then removed from the panel down to the tape label using a removal angle of 90 degrees at a rate of 2 in./sec (5.08 cm/sec). Finally, panels were visually inspected for both hot (149° F. (65° C.)) and cold (room temperature) removal areas for adhesive transfer, and results were reported to the nearest 5%, with 100% meaning that 100% of the adhesive was transferred and 0% meaning that no adhesive was transferred.

### Examples 1 to 9 and Control Examples A and B

The Examples and Control Examples were prepared by blending a mixture of NR Latex (or SBR Dispersion), Rosin Dispersion, and Sulfur Dispersion indicated in Table 2 (below) in a Tri-Pour plastic beaker using a wooden tongue depressor for 3 min. The amounts are weights of the dispersions in grams. A S-51 backing measuring 6-in. by 20-in. (15.24-cm by 50.8-cm) was clamped on an automatic film application (model ZAA2300.A, Screening Eagle Technologies, Zurich, Switzerland) with the backing's rough side facing up. The mixture was coated on the S-51 backing using a gap applicator (model Proceq ZUA 2000, Screening Eagle Technologies) with a coating speed of 2.5-mm/sec (0.09-in/sec, resulting in a 4.5-in.×16-in. (11.43-cm×40.64-cm) coated area. The gap on the gap applicator was set to 150 micrometers (0.006 in.) for coating Examples 1 to 4 and Control Example A, which resulted in a dry adhesive coating weight of 50+/−5 grams/(square meter) after drying the adhesive. The gap on the gap applicator was set to 100 micrometers (0.004 in.) for coating Examples 5 to 9 and Control Example B, which resulted in a dry adhesive coating weight of 35+/−3 grams/(square meter) after drying the adhesive. The coated backing was dried in a circulating air type electric oven (Despatch LFD series Oven, Model: LFD2-11-3, Despatch Industries) at 80° C. (176° F.) for 5 minutes. After drying, the sample was manually laminated onto the release side of a Loparex liner, and the laminate was then cut into 0.5-in.×13-in. (1.27-cm by 33-cm) tape sample strips for testing.

TABLE 2
Examples 1 to 9 and Control Examples A and B

| | | SBR | Rosin | Sulfur |
|---|---|---|---|---|
| | NR Latex | Dispersion | Dispersion | Dispersion |
| Example | (grams) | (grams) | (grams) | (grams) |
| Example 1 | 100 | 0 | 100 | 3 |
| Example 2 | 100 | 0 | 100 | 6 |
| Example 3 | 100 | 0 | 100 | 9 |
| Example 4 | 100 | 0 | 100 | 18 |
| Example 5 | 0 | 100 | 50 | 3 |
| Example 6 | 0 | 100 | 50 | 6 |
| Example 7 | 0 | 100 | 50 | 9 |
| Example 8 | 0 | 100 | 50 | 18 |
| Example 9 | 0 | 100 | 50 | 27 |
| Control A | 100 | 0 | 100 | 0 |
| Control B | 0 | 100 | 50 | 0 |

The test results of Examples 1 to 9 and Control Examples A and B are reported in Table 3, below.

TABLE 3
Test Results for Examples 1 to 9 and Control Examples A and B

| | Adhesion to | | Shear to | | |
|---|---|---|---|---|---|
| | Glass | Adhesion to | Steel | Adhesive Transfer | |
| Example | (oz/in) | Steel (oz/in) | (min) | Hot Peel | Cold Peel |
| Example 1 | 33.3 +/− 1.5 | 23.6 +/− 0.2 | 97 +/− 15 | 100% | 100% |
| Example 2 | 37.4 +/− 1.2 | 24.4 +/− 2.3 | 116 +/− 29 | 100% | 100% |
| Example 3 | 36.2 +/− 0.1 | 24.1 +/− 1.6 | 138 +/− 47 | 5% + heavy | 0% + light |
| | | | | ghosting | ghosting |
| Example 4 | 38.7 +/− 0.8 | 27.6 +/− 1.2 | 221 +/− 61 | 0% + light | 0% + light |
| | | | | ghosting | ghosting |
| Example 5 | 50.4 +/− 1.2 | 58.0 +/− 2.3 | 38 +/− 19 | 40% | 80% |
| Example 6 | 37.4 +/− 3.3 | 53.1 +/− 3.1 | 34 +/− 4 | 5% + | 0% + |
| | | | | ghosting | ghosting |
| Example 7 | 38.5 +/− 1.5 | 43.6 +/− 1.0 | 37 +/− 3 | 0% + | 0% + |
| | | | | ghosting | ghosting |
| Example 8 | 29.8 +/− 1.2 | 32.6 +/− 2.0 | 50 +/− 17 | 0% + light | 0% + light |
| | | | | ghosting | ghosting |
| Example 9 | 34.3 +/− 6.8 | 36.5 +/− 1.0 | 25 +/− 10 | 0% + light | 0% + light |
| | | | | ghosting | ghosting |
| Control A | 37.0 +/− 1.0 | 24.8 +/− 1.5 | 77 +/− 22 | 100% | 100% |
| Control B | 58.4 +/− 3.2 | 65.0 +/− 5.8 | 9 +/− 2 | 95% | 90% |

Various modifications and alterations of this disclosure may be made by those skilled the art without departing from the scope and spirit of the disclosure, and it should be understood that this invention is not to be unduly limited to the illustrative embodiments set forth herein.

1. A tape comprising:
a backing; and
a pressure-sensitive adhesive applied from an aqueous dispersion on the backing, the pressure-sensitive adhesive and comprising:
an at least partially crosslinked elastomer;
a tackifying resin; and
sulfur.

2. The tape of claim 1, wherein the at least partially crosslinked elastomer comprises at least one of natural rubber, synthetic polyisoprene rubber, styrene-butadiene rubber, styrene-isoprene-butadiene rubber, or acrylonitrile butadiene rubber.

3. The tape of claim 1, wherein the tackifying resin comprises at least one of a rosin acid, a rosin ester, a C5 aliphatic hydrocarbon resin, a C9 aromatic resin, or a mixed aliphatic-aromatic hydrocarbon resin.

4. The tape of claim 1, wherein the pressure-sensitive adhesive further comprises at least one of a vulcanization accelerator or a vulcanization activator.

5. The tape of claim 1, wherein the pressure-sensitive adhesive further comprises an antioxidant.

6. The tape of claim 1, wherein the pressure-sensitive adhesive further comprises a surfactant.

7. The tape of claim 1, wherein the backing comprises at least one of paper, polyester, poly(vinyl chloride), polypropylene, or polyethylene laminated cloth.

8. The tape of claim 1, wherein the tape is cleanly removable at a temperature in a range from room temperature to 150° C. from a surface after exposure to a temperature of at least 150° C. for at least 30 minutes, wherein the surface comprises at least one of glass, stainless steel, or a painted surface.

9. A process of making the tape of claim 1, the process comprising:
applying an aqueous dispersion of an elastomer, the tackifying resin, and the sulfur to the backing; and
drying the aqueous dispersion to provide the pressure-sensitive adhesive on the backing.

10. The process of claim 9, further comprising combining an elastomer aqueous dispersion, a tackifying resin aqueous dispersion, and a sulfur aqueous dispersion to provide the aqueous dispersion.

11. The process of claim 9, wherein the aqueous dispersion is substantially free of volatile organic solvent.

12. The process of claim 9, further comprising exposing the tape to radiation to crosslink at least the elastomer.

13. The process of claim 9, further comprising heating the tape to partially crosslink the elastomer with polysulfide bonds.

14. The process of claim 9, wherein the sulfur is present in a range from one percent to ten percent by weight, based on the weight of the elastomer and the sulfur in the aqueous dispersion.

15. A process of using the tape of claim 1, the process comprising:
applying the tape to a surface; and
exposing the surface to a temperature of at least 150° C.

16. The tape of claim 7, wherein the backing comprises paper.

17. The tape of claim 6, wherein the pressure-sensitive adhesive further comprises more than one surfactant.

18. The tape of claim 3, wherein the tackifying resin comprises at least one of a rosin acid or a rosin ester.

19. The tape of claim 1, wherein the at least partially crosslinked elastomer is a hydrocarbon elastomer.

20. The tape of claim 1, wherein the backing has a first face and a second face opposite the first face, wherein the pressure-sensitive adhesive is on the first face of the backing, and wherein the tape further comprises a low-adhesion backsize on the second face of the backing.
